(19) United States
(12) Patent Application Publication
(10) Pub. No.: US 2002/0130743 A1
(43) Pub. Date: Sep. 19, 2002

(54) Circuit breaker modular device reset

(76) Inventors: Roger Neil Castonguay, Terryville, CT (US); James Lawrence Rosen, West Hartford, CT (US); Girish Mruthunjaya Hassan, Seconderabad, IN (US)

Correspondence Address: PATENT OPERATION, GENERAL ELECTRIC COMPANY, 41 WOODFORD AVENUE, PLAINVILLE, CT, 06062

(21) Appl. No.: 09/681,284

(22) Filed: Mar. 13, 2001

(51) Int. Cl. H01H 9/20

(52) U.S. Cl. 335/166

(57) ABSTRACT

A circuit breaker modular device reset allows modular devices to be reset in a confined space with a minimal operating stroke. Modular devices include actuators such as flux shift units and accessories such as shunt trip devices and undervoltage devices. The reset device includes a support, a first leg and a second leg connected to the support via a trunk. A head is located at the distal end of the first leg. The modular device includes a reset tab. An interface used to reset an actuated modular device projects from the second leg and engages the reset tab during a modular device reset stroke.

### FIELD OF INVENTION

The invention relates generally to circuit breakers and, in particular, to circuit breakers having a modular device. The invention further relates to a circuit breaker modular device reset providing a modular device reset operation in a confined space with a reduced stroke and low operator force. The invention also relates to resetting a modular device located in a circuit breaker midcover.

### BACKGROUND OF INVENTION

Circuit breakers provide overcurrent protection and circuit isolation for electrical distribution systems. Circuit isolation occurs when electrical contacts located within the circuit breaker are open. The open contacts prevent the flow of electricity from an electrical energy source to an electrical load. Closed contacts complete the electrical circuit and connect the electrical energy source to the electrical load. An electric utility supply line is an example of an electrical energy source and a residential lighting circuit is an example of an electrical load. A circuit breaker operating mechanism allows movement of the electrical contacts between the circuit breaker”s open position and closed position.

Generally, circuit breakers are equipped with an operating handle extending outside the circuit breaker enclosure. The operating handle allows the operator to manually move the contacts between the open and the closed position from outside the enclosure.

A latch in the operating mechanism latches the circuit breaker in the closed position. The latch restrains the opening force of the opening springs, thereby holding the contacts in the closed position until a manual or automatic opening command is received by the circuit breaker. Automated circuit isolation occurs when an overcurrent protective device detects a potentially harmful electrical condition and sends an electrical signal to a trip coil or actuator. The actuator moves in a fixed operating stroke upon receipt of the electrical signal. The actuator movement triggers the latch thereby releasing the opening springs, driving the circuit breaker operating mechanism to the tripped position and opening the electrical contacts.

Modular devices such as shunt trip devices and undervoltage devices as well as actuators initiate operation of state of the art circuit breakers. Modular devices other than actuators are referred to as accessories. The actuator and accessories are referred to as modular because they are self contained units that can be easily installed in the circuit breaker housing as a unit. Generally, control wires interconnect the modular device to the control circuit that provides the electrical signal that initiates modular device operation. Accessory operation triggers the opening of the closed contacts as described for the actuator. The modular device operates in response to a user initiated control signal or automated detection of a potential damaging electrical condition. Modular device operation results in the modular device moving from a reset to an actuated position.

Modular devices are not self-resetting and will remain in the actuated position until they are returned to their reset position. The circuit breaker will not latch in the closed position so long as modular device remains in the actuated position. Therefore, circuit breakers include a crank or other reset device linking the operating mechanism to the modular device. The reset device resets the modular device when the operating mechanism is reset. Thus, the modular device does not interfere with circuit breaker closing operation and is ready to operate, if necessary, the moment that the circuit breaker closes.

Modern circuit breakers have become increasingly compact resulting in smaller modular devices having a minimal operating stroke. These circuit breakers require a reset device that has a corresponding minimal reset stroke. Additionally, the modular device reset must be accomplished with minimal force. The minimal force requirement stems from the fact that modern circuit breaker design allows manual circuit breaker operation with minimal force applied to the operating handle by operating personnel. The low force operation results in minimal force being applied to the crank or other reset device.

Many modern circuit breakers are also designed with a midcover secured to a base. Generally, these designs locate the operating mechanism in the base and the modular device in the midcover. The reset device must interconnect the operating mechanism to the modular device. The component separation increases the risk of misalignment between the modular device and the reset device. State of the art circuit breaker designs attempt to reduce the risk of misalignment by decreasing component tolerances. However, the tighter component tolerances result in more complex and costly manufacturing methods.

Finally, the geometry of some modern circuit breakers results in increased wear at the point where the reset device applies the resetting force to the modular device. The increased wear results from the fact that the modular device operating stroke and the reset device stroke are not parallel to one another. Typically the modular device operating stroke is linear. However, the resetting force may be generated by an arcuate motion. Generally, the modular device reset tab extends perpendicular from the modular device operator and the direction of the operating stroke. Thus, a resetting force applied substantially perpendicular to the modular device reset tab is more effective because it is parallel to the operating stroke.

Modern circuit breaker geometry found in some circuit breaker designs makes it difficult to optimize the force transfer by applying a force perpendicular to the modular device reset tab. The non-perpendicular force applied by the reset device to the modular device reset tab in some state of the art circuit breakers results in an inefficient and high friction sliding action between the components and results in increased wear on the reset device and the modular device reset tab.

### SUMMARY OF INVENTION

It is therefore advantageous to design a circuit breaker having a reset device with a minimal reset stroke. It is also desirable to provide a circuit breaker with a reset device capable of resetting a modular device when minimal force is applied to the circuit breaker operating handle. Additional advantages are provided when reset device operation is spring-free. Further advantages are provided by a circuit breaker with a high reliability reset device that does not require precise manufacturing tolerances. Advantages are also provided by a circuit breaker with a reset device that applies a reset force parallel to the modular device operating stroke.

Accordingly, the present invention provides a reset device that articulates a modular device between an actuated position and a reset position during a modular device reset stroke. The reset device includes a support, a trunk and at least one leg. A reset device operator moves in unison with a handle and articulates the reset device during the modular device reset stroke. Further, the modular device reset stroke occurs during a part of a circuit breaker reset stroke. Additionally, a method of articulating a modular device by applying a substantially perpendicular force to the modular device reset tab is provided. Additional objects, advantages and novel features of the invention will be set forth in part in the description which follows, and in part will become apparent to those skilled in the art upon examination of the following or may be learned by practice of the invention. The objects and advantages of the invention may be realized and attained by means of instrumentalities and combinations particularly pointed out in the appended claims.

### BRIEF DESCRIPTION OF DRAWINGS

FIG. 1 is a partially exploded isometric view of a circuit breaker equipped with a reset device in accordance with a preferred embodiment of the present invention;

FIG. 2 is a partially exploded isometric view of the circuit breaker of FIG. 1 viewed from the side opposite FIG. 1;

FIG. 3 is an isometric view of a partial circuit breaker of FIG. 1 and a modular device;

FIG. 4 is an isometric view of the modular device of FIG. 3 installed;

FIG. 5 is an isometric view of the internal components of the circuit breaker of FIG. 1;

FIG. 6 is a partially exploded isometric view of the internal components of FIG. 5;

FIG. 7 is a plan view of the reset device of the circuit breaker in FIG. 5 during the circuit breaker reset stroke;

FIG. 8 is a plan view of the reset device of the circuit breaker of FIG. 5 at completion of the modular device reset stroke; and

FIG. 9 is a plan view of the reset device of the circuit breaker of FIG. 5 at the completion of the circuit breaker reset operation.

### DETAILED DESCRIPTION

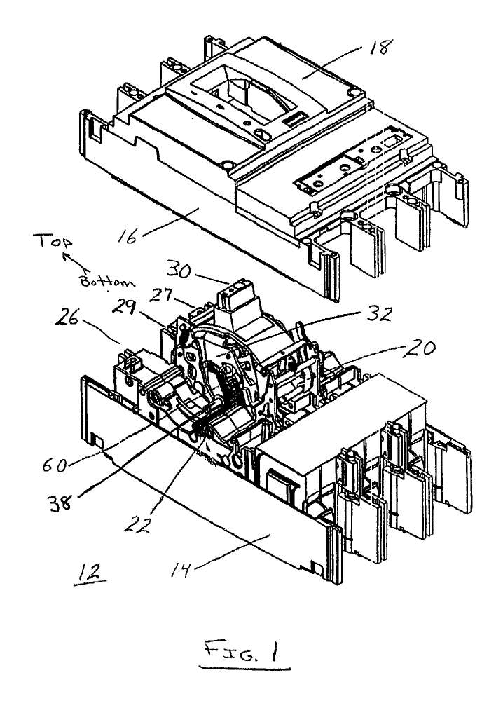

Electrical power systems are comprised of electrical generating equipment, transmission and distribution equipment and electrical loads such as lights and motors. Generally, the electrical load is located remotely from the generating station where the electricity is generated. Wires and cable comprise the transmission and distribution system that carries electrical current between the generating equipment and the electrical load. The electrical generating equipment, electrical load and the transmission and distribution systems can be damaged by excess current. Circuit breakers such as the multi-pole circuit breaker 12 in FIG. 1 are electrical switches employed at various points throughout the electrical power system to de-energize and isolate sections of the power system when a potentially damaging electrical condition is detected.

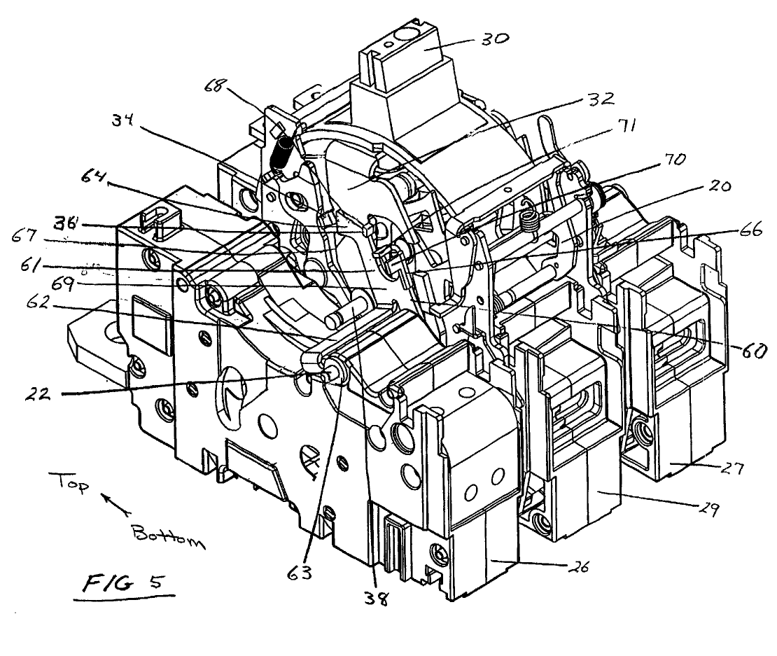

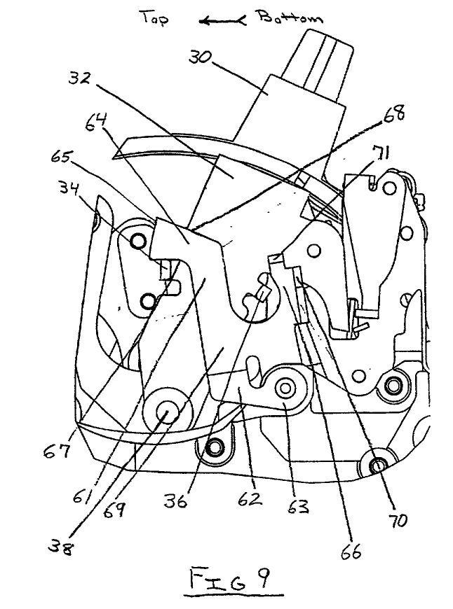

While the circuit breaker 12 is depicted and described herein as a three phase or three pole circuit breaker, the principles of the present invention disclosed herein are equally applicable to single phase or other polyphase circuit breakers and to both AC circuit breakers and DC circuit breakers. The top and bottom referred to in the figures refers to the relative position of circuit breaker components when the circuit breaker is mounted vertically. In this orientation, the circuit breaker 12 is closed when the handle 30 is moved to its topmost position (not shown). The handle 30 is in the reset position, FIG. 9, at the bottom of the handle stroke. The handle 30 is prevented from being forced further downward beyond the reset position. The handle 30 is in the open position (not shown) when it is slightly above the reset position and is in the tripped position, FIG. 1 and FIG. 5, at a point between the closed position and the open position. The handle 30 moves in an arc rotating around the handle pivot 38. These operating conditions are described in greater detail herein.

Referring to FIG. 1, a multi-pole circuit breaker 12 includes a housing consisting of a base 14, a midcover 16 and a front cover 18. In a preferred embodiment the circuit breaker 12 is a rotary circuit breaker. The circuit breaker 12 also includes a center interrupter 29. A first interrupter 26 is located in the base 14 adjacent and to the left of the center interrupter 29. A second interrupter 27 is located in the base 14 adjacent and to the right of the center interrupter 29. An operating mechanism 20 straddles the center interrupter 29. A handle 30 extends beyond the midcover 16 and front cover 18. The reset device operator 32 is attached to the handle 30 and changes positions in unison with the handle 30. In a preferred embodiment the reset device operator 32 is a handle yoke.

The handle 30 is electrically insulating and engages the operating mechanism 20 to allow a user to manually operate the circuit breaker 12 between an open position (not shown) and a closed position (not shown). The circuit breaker may also assume a tripped position, FIG. 1. Subsequent to a circuit breaker trip the circuit breaker 12 may be reset for further protective operation by moving the handle 30 from the tripped position beyond the open position to a reset position, FIG. 9. The handle 30 will automatically return to the open position after it is released from the reset position. The handle 30 may then be left in its open position or moved to its closed position, in which case the circuit breaker 12 is ready for a further protective operation.

At least one contact pair (not shown) located on within each interrupter 26, 27, 29, FIG. 1, are forced together when the circuit breaker 12 is closed. The contact pairs are comprised of a movable and stationary contact. Generally, springs (not shown) located in the operating mechanism 20 provide the energy for the rapid opening or closing of the contacts. Rapid operation reduces arcing and allows the circuit breaker 12 to safely interrupt higher magnitude current levels. At least one arc chute (not shown) is housed within each interrupter 26, 27, 29. The arc chutes provide a means of dispersing and cooling arcs formed when the circuit breaker 12 opens or closes an electrical circuit.

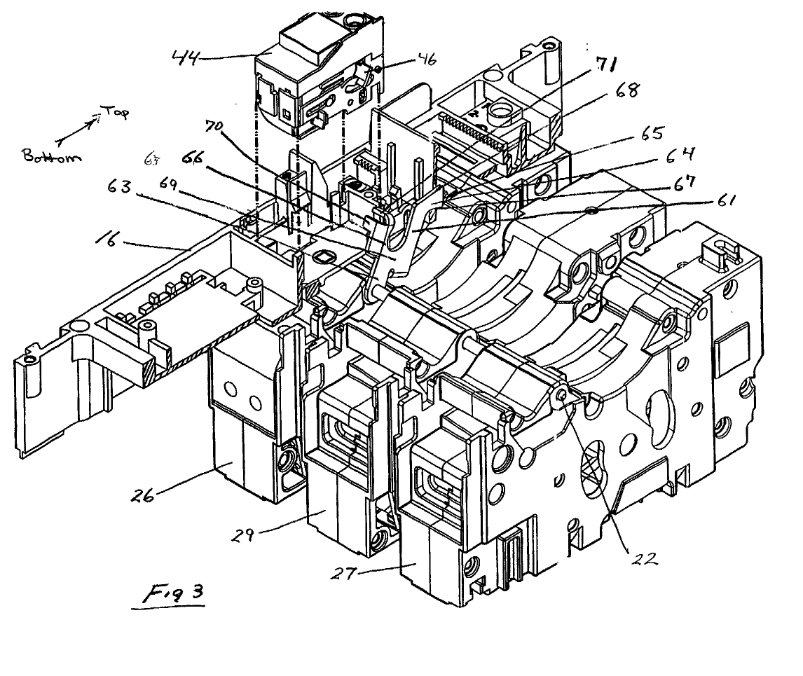

In addition to manual operation, the circuit breaker 12 can also be operated automatically and remotely. For example, an overcurrent trip occurs when an integral circuit breaker protective device (not shown) detects a potentially dangerous current level and sends an electrical signal to an integral modular device 44, FIG. 3. The modular device 44 may be in the form of an actuator such as a flux shift unit, trip coil and the like. The modular device 44 responds to the electrical signal by traveling from its reset position to its actuated position. Energy stored within the operating mechanism 20 of the closed circuit breaker 12 is released in response to the modular device travel. The operating mechanism 20 then articulates the moveable contact and associated linkage (not shown) to the tripped position where the contacts are open. The contacts remain open and cannot be reclosed until the operating mechanism 20 is reset by returning the handle 30 to its reset position. An actuated modular device 44 will prevent the circuit breaker 12 from closing until it is reset. Therefore, the modular device 44 is reset during the circuit breaker reset stroke. The circuit breaker reset stroke is the movement of the handle 30 from the tripped position to the reset position.

Generally, a remote trip is accomplished by issuing an electrical signal to a modular device 44 in the form of an accessory device such as a shunt trip, undervoltage device and the like. These modular devices 44 respond as described for the actuator type modular devices 44. As previously described, the circuit breaker 12 opens to the tripped position as a result of stored energy being released by the operating mechanism 20. The electrical signal that initiates circuit breaker operation may be operator initiated or occur automatically in response to a specific electrical condition such as an undervoltage, overvoltage, phase reversal, phase loss and the like.

Referring to FIG. 5, the operating mechanism 20 is reset when the handle 30 is pulled downward to the reset position shown in FIG. 9. The operating mechanism 20 can be reset in this fashion because the handle 30 is attached to the operating mechanism 20 on the base 14. However, to reset the modular device 44, a reset device 60 is required to interconnect the modular device 44, located in midcover 16, see FIG. 3, to the handle 30 via reset device operator 32. Additionally, circuit breaker geometry makes it difficult to apply a resetting force parallel to the modular device operating stroke directly from the reset device operator 32. The reset device 60 is configured to optimize the force transfer from the reset device operator 32 to the modular device 44.

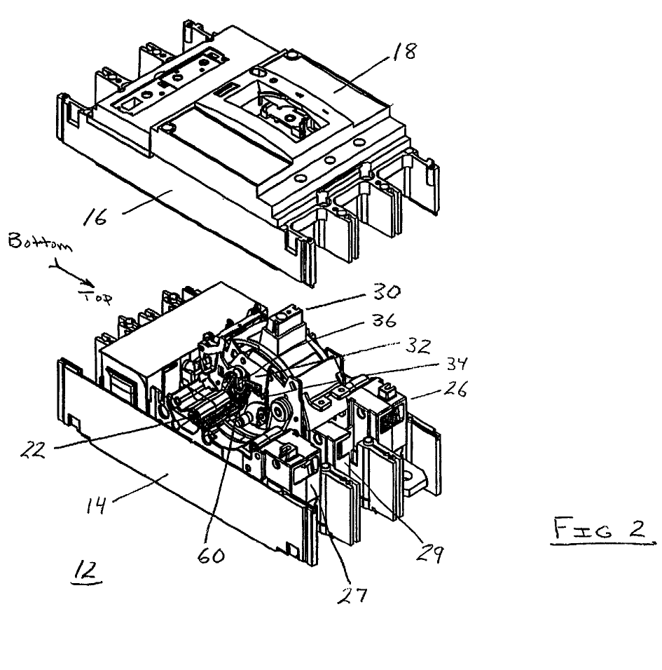

In a preferred embodiment the circuit breaker 12 includes a first reset device and a second reset device. FIG. 1 is a view of the circuit breaker from its left side therefore, FIG. 1 shows the left side view of a reset device 60 in the form of a crank located on the left side of the circuit breaker 12. FIG. 2 depicts the right side of the circuit breaker 12. Consequently, FIG. 2 shows the reset device 60 located on the right side of the circuit breaker 12. The reset devices 60 installed on opposite sides of circuit breaker 12 are mirror images of one another. Typically, an actuator type modular device 44 is located on one side of the operating mechanism 20 while an accessory type modular device 44 is located on the opposite side of the operating mechanism 20.

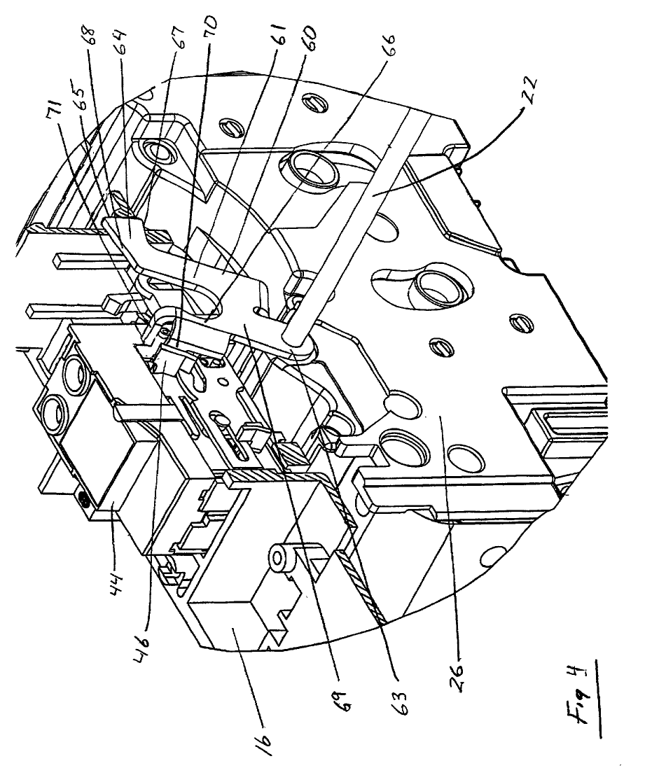

FIG. 4, shows a reset device 60 and a modular device 44 installed over the first interrupter 26 located to the left of the center interrupter 29 (not shown in this view) and operating mechanism 20 (not shown in this view). The modular device 44 is installed in the midcover 16 as previously described. The reset device 60 is independent of midcover 16. The reset device 60 straddles the first interrupter 26 where it is pivotally mounted on rod 22. A support 62 provides a stable platform that prevents lateral forces from shifting the reset device 60 out of position.

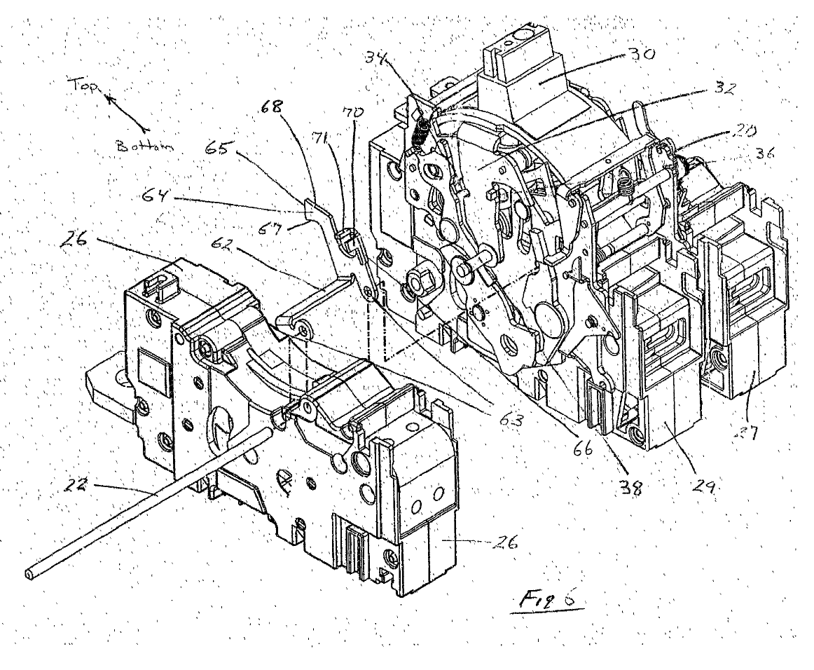

Referring to FIG. 6, the reset device 60 includes the support 62, lobes 63, a trunk 69, a first leg 61, a second leg 66, a head 64, an interface 70 and a rejection tab 71. The support 62 spans the first interrupter 26 and has a single lobe 63 located at either end of the support 62. The support 62 is wide enough such that a lobe 63 is located on either side of first interrupter 26 when the reset device 60 is installed. A hole is centrally located within each lobe 63. The rod 22 spans the width of the assembled interrupters 26, 27, 29. The rod 22 slides through the first of two lobes 63, through the first interrupter 26, through the second of two lobes 63, through the operating mechanism 20 and center interrupter 29, and through the second interrupter 27 and reset device 60 straddling the second interrupter 27 in the manner described for the first interrupter 26. In a preferred embodiment the rod 22 also aligns the interrupters 26, 27, 29 within the base 14.

The first leg 61 and second leg 66 are connected to the support 62 via a trunk 69. It is referred to as a trunk because it is the main body of the reset device 60 and has appendages in the form of the first leg 61 and second leg 66 extending from it. FIG. 4 shows that the trunk 69, first leg 61 and second leg 66 project at a ninety-degree angle from the support 62 in a direction away from the associated interrupter 26 or 27. Each leg 61, 66 projects from the interrupter through the midcover 16 where they engage additional circuit breaker 12 components as described herein.

A head 64 is located at the distal end of the first leg 61 extending at an angle away from the first leg 61 in the same plane as the first leg 61. A rejection tab 71 is located at the distal end of the second leg 66. The rejection tab 71 projects at a ninety-degree angle away from the operating mechanism 20, FIG. 5, in a plane perpendicular to the second leg 66. The rejection tab 71 prevents a modular device 44 from being improperly oriented when it is installed.

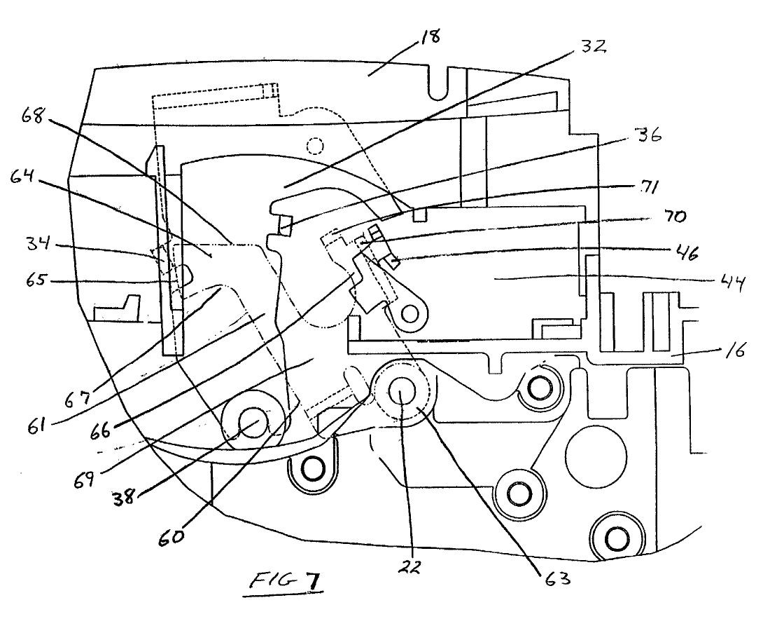

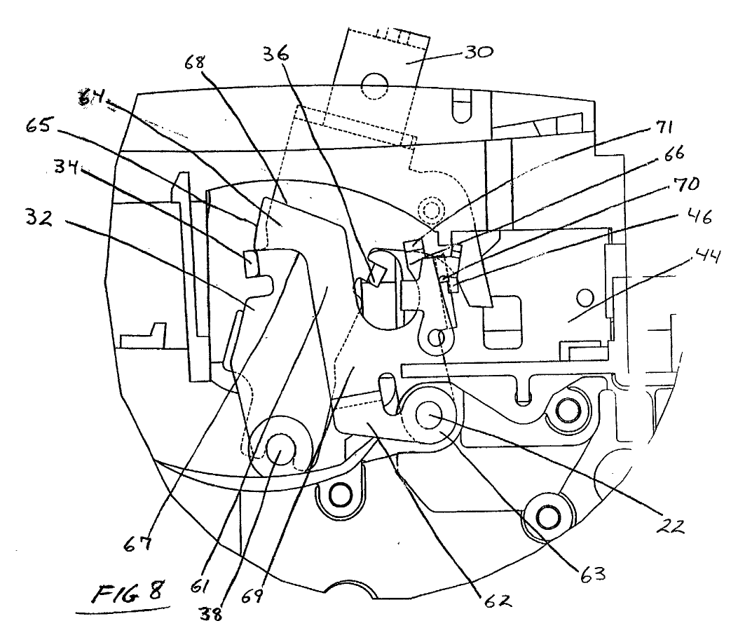

An interface 70 also projects from the second leg 66. In a preferred embodiment the interface 70 projects at a ninety-degree angle away from the operating mechanism 20, FIG. 5, in a plane perpendicular to the second leg 66. This configuration allows the interface 70 to engage the modular device reset tab 46 and articulate the modular device 44 between the actuated position and the modular device reset position during the modular device reset stroke. The modular device reset stroke is the movement whereby the modular device 44 is moved from its actuated position, FIG. 3 and FIG. 7, to its reset position, FIG. 8, by the reset device 60. The modular device reset stroke occurs during a segment of the circuit breaker reset stroke. The modular device reset force is applied substantially perpendicular to the reset tab 46 as a result of the orientation of interface 70. A substantially perpendicular modular device reset force is one that is sufficiently perpendicular to the reset tab 46 to reduce the amount of sliding action between the interface 70 surface and the reset tab 46 such that wear is reduced and only a minimal operating force need be applied to the handle 30 to reset the modular device 44.

The head 64, FIG. 4, includes a face 65, an inner edge 67 that runs between the face 65 and the first leg 61 and an outer edge 68 that runs between the face 65 and the trunk 69. FIG. 5 depicts the reset device 60 installed to the left of the operating mechanism 20 straddling the first interrupter 26. The head 64 is located between a first tab 34 and a second tab 36 located on the left side of reset device operator 32 when the circuit breaker 12 is assembled. A second set of tabs 34, 36 are located on the reset device operator 32 to the right of the operating mechanism 20, FIG. 2, in a mirror image of the tabs 34, 36 shown in FIG. 5. The head 64 of the right hand reset device 60 is located between the first and second tabs 34, 36 on the right hand side of reset device operator 32 when the circuit breaker 12 is assembled.

FIG. 5 depicts the position of the handle 30, reset device operator 32 and reset device 60 following a circuit breaker trip. FIG. 7 depicts the reset device 60 when reset device operator 32 first engages it during the circuit breaker reset stroke. Handle movement from the tripped to the reset position articulates the reset device 60 by engaging the first tab 34 with the face 65 of reset device 60. The reset device 60 of FIG. 7 pivots around rod 22 in the clockwise direction as the handle 30 is moved to the reset position. The first tab 34 pushes against the face 65 as the reset device 60 rotates about rod 22. The modular device reset stroke is completed when the modular device 44 is reset. The modular device 44 is reset prior to the handle 30 being rotated about handle pivot 38 to the reset position. In a preferred embodiment the modular device 44 is reset with the handle 30 at least about eight degrees of rotation from the reset position and more preferably at least twelve degrees of rotation from the reset position. Finally, in a most preferred embodiment the modular device 44 is reset with the handle 30 at least fifteen degrees of rotation from the reset position.

The first tab 34 continues move along the face until it reaches the inner edge 67, FIG. 8. The circuit breaker reset stroke is not complete at this point. Further handle rotation is required to reset the operating mechanism 20 such that the operating mechanism 20 is charged and latched for a closing operation. However, the modular device 44 is fully reset at this point of the circuit breaker reset stroke and the modular device is in the modular device reset position. The modular device 44 would be damaged if additional reset force were applied.

It should be noted that the handle position by itself does not describe the advantage provided by the invention. It is the difference in handle position between the point the modular device 44 is reset and the point where the final portion of the reset stroke begins, described herein, that most clearly demonstrates the advantage. The greater the difference in handle position between the two points the greater the allowable manufacturing tolerance. This advantage is particularly useful because the modular device 44 is installed in the midcover 16 and the reset device 44 is installed in the base 14. Thus, the invention allows for less precise alignment between the base 14 and midcover 16 without any reduction in performance.

The invention eliminates the risk of damage to the modular device 44 by preventing any further rotation of the reset device 60. The continued handle movement does not rotate the reset device 60 any further because the first tab 34 does not push against the reset device 60 during the remainder of the handle stroke but slides along the inner edge 67. The inner edge 67 is also referred to as a dwell surface. The reset device”s reduced stroke as compared to the stroke of the handle 30 and reset device operator 32 accommodates the short operating stroke of the modular device 44. The invention provides modular device resetting prior to completion of the circuit breaker reset stroke. In a preferred embodiment the first tab 34 slides along the inner edge 67 during at least the final three degrees of handle rotation and more preferably the final six degrees of rotation. In a most preferred embodiment the first tab 34 slides along the inner edge 67 during at least the final twelve degrees of handle rotation.

The handle position provides a reference wherein the point of engagement between the first tab 34 and the inner edge 67 can be compared with completion of the resetting of the modular device 44. The start of engagement between the first tab 34 and the inner edge 67 should occur after completion of modular device resetting and prior to the start of the final portion of the circuit breaker reset stroke.

The invention provides the additional benefit of reduced operating force because the modular device 44 is reset before the operating mechanism 20 is latched. The operating mechanism 20 is not latched until the final portion of the circuit breaker reset stroke. In a preferred embodiment the final portion of the circuit breaker reset stroke occurs during the final three degrees of handle rotation and more preferably during the final two and one half degrees of rotation. Finally, in a most preferred embodiment the final portion of the circuit breaker reset stroke occurs during the final two degrees of handle rotation, therefore the operating mechanism latching force and the modular device resetting force are not applied simultaneously. The final portion of the circuit breaker reset stroke can be expanded so long as the operator mechanism latching force and the modular device resetting force are not applied simultaneously. However, as mentioned previously, the invention”s advantages are greater when the final portion of the reset stroke is reduced because allowable manufacturing tolerances are increased.

The increased tolerances result from any difference in the handle position between the end of the modular device reset stroke and the start of the final portion of the circuit breaker reset stroke. The greater the difference the greater the allowable tolerances. For example, in a preferred embodiment the difference is five degrees of handle rotation. Thus, the modular device alignment can vary without affecting circuit breaker performance so long as the first tab 34 is located along the inner edge 67 at the start of the final portion of the circuit breaker reset stroke.

The circuit breaker 12 of FIG. 9 is shown in the reset position. The first tab 34 is located along the inner edge 67 of the head 64. The second tab 36 is located adjacent the second leg 66. The position of the tabs 34, 36 shifts slightly when the handle 30 comes to rest in the open position. In the open position, the first tab is located on the inner edge 67 where the face 65 and the inner edge 67 meet. The second tab 36 comes to rest approximately midway between the first leg 61 and the second leg 66.

Once the circuit breaker is reset, a closing stroke of handle 30 returns the reset device 60 to a normal position wherein the interface 70 will not interfere with the reset tab 46 should the modular device 44 actuate. Pushing the handle 30 upward towards the top of the circuit breaker 12 closes the circuit breaker 12. As the handle 30 is pushed upward the second tab 36 engages the outer edge 68 of the first leg 61 and pushes the reset device 60 counterclockwise. The second tab 36 slides along the outer edge 68 of the first leg 61 where it reaches the head 64. Further movement of the handle 30 in the upward direction, counterclockwise in FIG. 9, forces the second tab 36 of reset device operator 32 to slide along the outer edge 68 of head 64. In the fully closed position, the reset device 60 comes to rest in its normal position, the second tab 36 comes to rest along the outer edge 68 approximately halfway between the distal end of first leg 61 and the face 65 of head 64.

Spring-free operation of reset device 60 results from the configuration of reset device operator 32 and the reset device 60. Thus, no springs are used to move the reset device 60 between the normal position and the reset position. The reduced component count increases reliability and reduces manufacturing costs.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A circuit breaker, comprising:
a housing;
at least one contact pair comprised of a movable contact and a stationary contact;
an operating mechanism, wherein said operating mechanism articulates the moveable contact of said contact pair between an open position and a closed position;
a handle;
a reset device operator that moves in unison with movement of said handle, wherein said reset device operator articulates at least one reset device during a modular device reset stroke; and
a first reset device, said reset device being responsive to movement of said handle between a tripped position and an open position for articulating a modular device from an actuated position to a modular device reset position during a modular device reset stroke, said modular device reset stroke occurring during only a segment of a circuit breaker reset stroke.

2. The circuit breaker of claim 1, wherein said operating mechanism is not latched during said modular device reset stroke.

3. The circuit breaker of claim 1, wherein said segment does not include a final portion of said circuit breaker reset stroke, said operating mechanism latching during said final portion.

4. The circuit breaker of claim 3, wherein said final portion is eight degrees or less of rotation of said handle.

5. The circuit breaker of claim 4, wherein said final portion is three degrees or less of rotation of said handle.

6. The circuit breaker of claim 1, wherein a circuit breaker closing stroke results in a spring-free return of said first reset device to a normal position.

7. The circuit breaker as claimed in claim 1, wherein said first reset device is comprised of a support and at least one leg connected to said support via a trunk.

8. The circuit breaker as claimed in claim 7, wherein said reset device operator has a first set of tabs comprised of a first tab and a second tab.

9. The circuit breaker as claimed in claim 8, wherein said first tab engages a head located at the distal end of a first leg of said first reset device during said modular device reset stroke.

10. The circuit breaker as claimed in claim 9, wherein said first reset device has a second leg with an interface projecting from said second leg.

11. The circuit breaker as claimed in claim 10, wherein said interface applies a reset force to a reset tab of said modular device during said modular device reset stroke.

12. The circuit breaker as claimed in claim 11, wherein said reset force is substantially perpendicular to said reset tab of said modular device.

13. The circuit breaker as claimed in claim 12, wherein said reset device operator includes a second set of tabs.

14. The circuit breaker as claimed in claim 13, wherein said second set of tabs articulate a second reset device.

15. The circuit breaker as claimed in claim 14, wherein said reset device operator is a handle yoke.

16. The circuit breaker as claimed in claim 8, wherein said second tab engages an outer edge of a first leg of said reset device to articulate said reset device to said normal position when said handle is moved from an open position to a closed position.

17. The circuit breaker as claimed in claim 16, wherein said reset device operator includes a second set of tabs.

18. The circuit breaker as claimed in claim 17, wherein said second set of tabs articulate a second reset device.

19. The circuit breaker as claimed in claim 18, wherein said reset device operator is a handle yoke.

20. A reset device for resetting a modular device of a circuit breaker, comprising:
a support; and
a trunk projecting perpendicular from said support, wherein a first leg and a second leg are attached perpendicular to said support via said trunk.

21. The reset device as claimed in claim 20, wherein a head is located at the distal end of said first leg.

22. The reset device as claimed in claim 21, wherein an interface projects from said second leg.

23. The reset device as claimed in claim 22, wherein a reset device operator articulates said reset device by engaging a face of said head during a portion of a circuit breaker reset stroke.

24. The reset device as claimed in claim 23, wherein said interface articulates said modular device between an actuated position and a reset position during a modular device reset stroke.

25. The reset device as claimed in claim 24, wherein said modular device is mounted in a midcover of said circuit breaker.

26. The reset device as claimed in claim 25, wherein said reset device is mounted independent of said midcover.

27. The reset device as claimed in claim 26, wherein said reset device is mounted in a base of said circuit breaker.

28. The reset device as claimed in claim 27, wherein said reset device is pivotally mounted.

29. The circuit breaker as claimed in claim 24, wherein said modular device is an accessory device.

30. The circuit breaker as claimed in claim 29, wherein said accessory device is a shunt trip device.

31. The circuit breaker as claimed in claim 29, wherein said accessory device is an under voltage device.

32. The circuit breaker as claimed in claim 24, wherein said modular device is an actuator.

33. The circuit breaker as claimed in claim 32, wherein said actuator is a flux shift unit.

34. A method of articulating a modular device of a circuit breaker by applying a substantially perpendicular force to a modular device, comprising the steps of:
equipping said circuit breaker with a reset device having a head and an interface;
equipping said circuit breaker with said a modular device having a reset tab;
equipping said circuit breaker with a reset device operator having a first tab, wherein said first tab engages said head and articulates said reset device during a modular device reset stroke;
configuring said reset device and said reset device operator such that said modular device reset stroke occurs during a portion of a circuit breaker reset stroke;
orienting said interface such that said substantially perpendicular force is applied by the interface to said reset tab during said modular device reset stroke; and
operating said circuit breaker through the circuit breaker reset stroke.

35. The method of claim 34, wherein operation of said reset device is spring-free.

36. The method of claim 34, wherein said head is located at the distal end of a first leg of said reset device.

37. The method of claim 36, wherein said interface projects from a second leg of said reset device.
